(19) United States
(12) Patent Application Publication
(10) Pub. No.: US 2023/0105584 A1
(43) Pub. Date: Apr. 6, 2023

(54) SOLUBLE SUPPORT MATERIALS FOR ADDITIVE MANUFACTURING

(71) Applicant: ELKEM SILICONES SHANGHAI CO., LTD., Shanghai (CN)

(72) Inventors: Liya JIA, Shanghai (CN); Yuanzhi YUE, Shanghai (CN); Chen SI, Shanghai (CN)

(21) Appl. No.: 17/790,361

(22) PCT Filed: Dec. 31, 2019
(86) PCT No.: PCT/CN2019/130516

§ 371 Date: Jun. 30, 2022

(51) Int. Cl. C09D 11/322; C09D 11/037; C09D 11/102; B33Y 70/00; B29C 64/40; B29C 64/30; B33Y 10/00; B33Y 40/20

(52) U.S. Cl. CPC C09D 11/322; C09D 11/037; C09D 11/102; B33Y 70/00; B29C 64/40; B29C 64/30; B33Y 10/00; B33Y 40/20; B29K 2083/00

(57) ABSTRACT

The present invention refers to a method for additive manufacturing a silicone elastomer article using a 3D printer selected from an extrusion 3D printer and a 3D jetting printer, in which a soluble support material composition V is used, which comprises: (A) at least one polyorganosiloxane, (B) at least one polyether or polymer containing polyether moiety, (C) silica; to a silicone elastomer article obtainable by the method of present invention; and to the use of a support material composition V for 3D printing a support, preferably by extrusion.

### TECHNICAL FIELD

The present invention refers to a method for additive manufacturing a silicone elastomer article using a 3D printer selected from an extrusion 3D printer and a 3D jetting printer, in which a soluble support material composition V is used, which comprises: (A) at least one polyorganosiloxane, (B) at least one polyether or polymer containing polyether moiety, (C) silica; to a silicone elastomer article obtainable by the method of present invention; and to the use of a support material composition V for 3D printing a support, preferably by extrusion.

### BACKGROUND ART

Additive manufacturing cover different techniques whose common feature is an automatic additive buildup of layers of the shaped parts. Additive manufacturing techniques are used in printed 3D models based on layer by layer method. Different manufacturing processes are employed to achieve construction of 3D objects including extrusion, ink jetting, selective laser sintering, electron-beam melting, and stereolitho-electrophotography based on properties of materials. For example, Fused Deposition Modelling (FDM) process can use thermal properties of thermoplastic polymers to build a 3D object. Further, some polymers with photosensitive groups can be printed via Stereo lithography Appearance (SLA) or UV-Digital Light processing (DLP) processes.

In order to additive manufacture an object having a complex shape, for example, having overhanging structures or cavities, it is sometimes necessary to use a support material during the manufacturing of the object. No matter what manufacturing technique is used, a support material plays an important role in achieving high precision, high complexity in the manufacturing of the object. For example, a support material can support overhanging structures that are not supported directly by a building material of the final geometry. A support material can also decrease warpage of a building material and prepare a hollow structure.

Generally, some thermoplastics polymers are used as support materials for FDM, STL or DLP processes. According to U.S. Pat. No. 5,503,785, EP1773560, WO2010045147 and U.S. Pat. No. 10,259,921B2, thermoplastics polymers can be extruded through a nozzle as liquid and are generally solid at ambient temperature.

However, the above support materials cannot be used in additive manufacturing processes based on silicone compositions. Crosslinking silicone compositions have already been used in additive manufacturing methods to produce a three dimensional (3D) elastomer silicone article or part, due to the unique thermal properties of silicone system such as lower glass transition temperature.

US20180057682A1 discloses an organic microgel system for 3D printing of silicone structures, which comprises an organic solvent and a block copolymer.

EP3227116B1 discloses a phase changing material used as a support system during 3D printing. The phase changing material can be removed via change of yield stress induced by mechanical force, light, radiation or electricity.

WO2015/107333 A1 describes a 3D printing method for producing prostheses from silicone elastomers by (continuous) extrusion of the crosslinkable silicone rubber composition from a mixer nozzle. The 3D printing is optionally assisted by a second mixer nozzle for extruding a thermoplastic material which serves as a support material for the silicone rubber composition to be printed.

WO2019215190 describes a support material consisting of water and poloxamer, which can form gel at 20-50° C. and become liquid status below 15° C. based on sol-gel transition temperature.

As the techniques as disclosed in these prior art documents still have some drawbacks, there is a need to provide an improved method for additive manufacturing a 3D print silicone elastomer article having improved properties.

### CONTENTS OF THE INVENTION

Accordingly, an objective of the present invention is to provide a method for additive manufacturing a silicone elastomer article having a complex shape and/or having a smooth surface.

Another objective of the present invention is to provide a method for additive manufacturing a silicone elastomer article by using a building material composition and a support material composition, wherein preferably, the support material keeps shaping well and can be easily removed, for example, by dissolution in a solvent, preferably in water, and/or mechanically, and/or wherein preferably, the silicone elastomer article obtained has a complex structure and/or has a surface with high precision.

Further another objective of the present invention is to provide a method for additive manufacturing a silicone elastomer article and a support.

Another objective of the present invention is to provide a method for additive manufacturing a silicone elastomer article and a support, wherein the method is easy to implement, and/or wherein the silicone elastomer article obtained has a complex structure and/or has a surface with high precision.

Further objective of the present invention is to provide a support which could be used for additive manufacturing a silicone elastomer article.

These objectives, among others, are achieved by the present invention which relates first to a method for additive manufacturing a silicone elastomer article using a 3D printer selected from an extrusion 3D printer and a 3D jetting printer, said method comprising the steps of:

1) printing at least one part of a support material composition V, wherein the support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof;

2) printing at least one part of a building material composition, which is a crosslinkable silicone composition X precursor of the silicone elastomer article;

steps 1) and 2) being done simultaneously or successively, and when steps 1) and 2) are done successively, step 1) can be performed before step 2), or step 2) can be performed before step 1);

3) optionally repeating step 1) and/or step 2); and

4) allowing the crosslinkable silicone composition X precursor of the silicone elastomer article to crosslink, optionally by heating, to obtain a silicone elastomer article;

5) removing the support material, for example, by dissolution in a solvent, preferably in water, and/or mechanically.

The present invention also relates to a method for additive manufacturing a silicone elastomer article and a support using a 3D printer selected from an extrusion 3D printer and a 3D jetting printer, said method comprising the steps of:

1) printing at least one part of the support with a support material composition V, wherein the support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof;

2) printing at least one part of a building material composition, which is a crosslinkable silicone composition X precursor of the silicone elastomer article;

steps 1) and 2) being done simultaneously or successively, and when steps 1) and 2) are done successively, step 1) can be performed before step 2), or step 2) can be performed before step 1);

3) optionally, repeating step 1) and/or step 2); and

4) allowing the crosslinkable silicone composition X precursor of the silicone elastomer article to crosslink, optionally by heating, to obtain a silicone elastomer article.

The support material composition V comprising the components A to C has good thixotropic properties. In particular, it avoids the collapse or deformation of the printed silicone composition. Silicone elastomer articles with a complex shape, like overhanging structures, can thus be printed using this method. Further, the support material composition V may not react or less react with the building material composition and/or may not inactivate the catalyst in the building material composition. Also, the support material has good solubility in a solvent or in water, such that the support material is easily removable when it needs to be removed. In particular, the support material is water-soluble and therefore environmentally friendly. Furthermore, the support material composition V can be prepared in a simple way by using readily available raw materials.

The present invention also relates to a silicone elastomer article obtainable by the method according to the present invention.

The present invention further relates to the use of a support material composition V in 3D printing, for example by using a 3D printer selected from an extrusion 3D printer and a 3D jetting printer, wherein the support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof.

The present invention further relates to the use of the support material composition V for 3D printing a support, preferably by extrusion.

The present invention still further relates to a support material composition V comprising:

(A) at least one polyorganosiloxane A, preferably linear polyorganosiloxane;

(B) at least one polyether or polymer containing polyether moiety B;

(C) silica C, preferably selected from fumed silica, precipitated silica or the mixture thereof, wherein the support material composition is preferably used in 3D printing, for example by using a 3D printer selected from an extrusion 3D printer and a 3D jetting printer.

The present invention also relates to a method for additive manufacturing a silicone elastomer article by using the support material composition V according to the present invention.

Method for Additive Manufacturing

3D printing is generally associated with a host of related technologies used to fabricate physical objects from computer generated, e.g. computer-aided design (CAD), data sources.

This disclosure generally incorporates ASTM Designation F2792-12a, “Standard Terminology for Additive Manufacturing Technologies”.

“3D printer” is defined as “a machine used for 3D printing” and “3D printing” is defined as “the fabrication of objects through the deposition of a material using a print head, nozzle, or another printer technology.”

“Additive manufacturing (AM)” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication.” Additive manufacturing (AM) may also be referred to as rapid prototyping (RP). As used herein, “3D printing” is generally interchangeable with “additive manufacturing” and vice versa.

“Printing” is defined as depositing of a material, here a crosslinkable silicone composition or a support material composition, using a print head, nozzle, or another printer technology.

In this disclosure “3D or three dimensional article, object or part” means an article, object or part obtained by additive manufacturing or 3D printing as disclosed above.

In general, all 3D printing processes have a common starting point, which is a computer generated data source or program which may describe an object. The computer generated data source or program can be based on an actual or virtual object. For example, an actual object can be scanned using a 3D scanner and scan data can be used to make the computer generated data source or program. Alternatively, the computer generated data source or program may be designed from scratch.

The computer generated data source or program is typically converted into a standard tessellation language (STL) file format; however other file formats can also or additionally be used. The file is generally read into 3D printing software, which takes the file and optionally user input to separate it into hundreds, thousands, or even millions of “slices.” The 3D printing software typically outputs machine instructions, which may be in the form of G-code, which is read by the 3D printer to build each slice of the support and of the precursor of the silicone elastomer article. The machine instructions are transferred to the 3D printer, which then builds the objects (support and precursor of the silicone elastomer article), layer by layer, based on this slice information in the form of machine instructions. Thicknesses of these slices may vary.

Typically, the 3D printer utilizes a dispenser, e.g. a nozzle or print head, for printing the crosslinkable silicone composition X precursor of the silicone elastomer article and another dispenser for printing the support composition material V. Optionally, the dispensers may be heated before, during, and after dispensing the crosslinkable silicone composition X precursor of the silicone elastomer article and/or the support composition material V. More than one dispenser may be utilized with each dispenser having independently selected properties.

An extrusion 3D printer is a 3D printer where the material is extruded through a nozzle, syringe or orifice during the additive manufacturing process. The 3D printer can have one or more nozzle, syringe or orifice. Preferably, the 3D printer has at least 2 nozzles, syringes or orifices for the additive manufacturing process. Material extrusion generally works by extruding material through a nozzle, syringe or orifice to print one cross-section of an object, which may be repeated for each subsequent layer. The extruded material bonds to the layer below it during cure of the material. Advantageously, the crosslinkable silicone composition X precursor of the silicone elastomer article is extruded through a nozzle and the support composition V is extruded through another nozzle. The nozzles may be heated to aid in dispensing the crosslinkable silicone composition X precursor of the silicone elastomer article or the support material composition V.

The average diameter of the nozzle defines the thickness of the layer. In an embodiment, the diameter of the nozzle is comprised from 50 to 5,000 μm, preferably from 100 to 800 μm and most preferably from 100 to 500 μm.

The distance between the nozzle and the substrate is an important parameter to assure good shape. Preferably it is comprised from 70 to 200%, more preferably from 80 to 120% of the nozzle average diameter.

The crosslinkable silicone composition X precursor of the silicone elastomer article and the support material composition V to be dispensed through the nozzles may be supplied from cartridge-like systems. The cartridges may include a nozzle or nozzles with an associated fluid reservoir or fluids reservoirs. It is also possible to use a coaxial two cartridges system with a static mixer and only one nozzle. This is especially useful when the crosslinkable silicone composition X precursor of the silicone elastomer article is a multi-part composition.

Pressure will be adapted to the fluid to be dispensed, the associated nozzle average diameter and the printing speed.

Because of the high shear rate occurring during the nozzle extrusion, the viscosity of the crosslinkable silicone composition X precursor of the silicone elastomer article and the support material composition V are greatly lowered and so permit the printing of fine layers.

Cartridge pressure could vary from 1 to 28 bars, preferably from 2 to 25 bars and most preferably from 4 to 8 bars. When nozzle diameters lower than 100 μm are used, cartridge pressure shall be higher than 20 bars to get good material extrusion. An adapted equipment using aluminum cartridges shall be used to resist such a pressure.

The nozzle and/or build platform moves in the X-Y (horizontal plane) to complete the cross section of the object, before moving in the Z axis (vertical) plane once one layer is complete. The nozzle has a high XYZ movement precision around 10 μm. After each layer is printed in the X, Y work plane, the nozzle is displaced in the Z direction only far enough that the next layer can be applied in the X, Y work place. In this way, the objects which become the support or the precursor of the silicone elastomer article can be built one layer at a time from the bottom upwards.

As disclosed before, the distance between the nozzle and the previous layer is an important parameter to assure good shape. Preferably, it should be comprised from 70 to 200%, preferably from 80 to 120% of the nozzle average diameter.

Advantageously, printing speed is comprised between 1 and 100 mm/s, preferably between 3 and 50 mm/s to obtain the best compromise between good accuracy and manufacture speed.

“Material jetting” is defined as “an additive manufacturing process in which droplets of build material are selectively deposited”. The material is applied with the aid of a printing head in the form of individual droplets, discontinuously, at the desired location of the work plane (Jetting). 3D apparatus and a process for the step-by-step production of 3D structures with a printing head arrangement comprising at least one, preferably 2 to 200 printing head nozzles, allowing the site-selective application where appropriate of a plurality of materials. The application of the materials by means of inkjet printing imposes specific requirements on the viscosity of the materials.

In a 3D jetting printer one or a plurality of reservoirs are subject to pressure and being connected via a metering line to a metering nozzle. Upstream or downstream of the reservoir there may be devices which make it possible for multicomponent silicone compositions to be homogeneously mixed and/or to evacuate dissolved gases. One or a plurality of jetting apparatuses operating independently of one another may be present, to construct the support and the precursor of the silicone elastomer article, to construct the precursor of the silicone elastomer article from different silicone compositions, or, in the case of more complex structures, to permit composite parts made from silicone elastomers and other plastics.

Because of the high shear rate occurring in the metering valve during the jetting metering procedure, the viscosity of such silicone compositions and support material composition is greatly lowered and so permits the jetting metering of very fine microdroplets. After the microdrop has been deposited on the substrate, there is a sudden reduction in its shear rate, and so its viscosity climbs again. Because of this, the deposited drop rapidly becomes of high viscosity again and permits the shape-precise construction of three-dimensional structures.

The individual metering nozzles can be positioned accurately in x-, y-, and z-directions to permit precisely targeted deposition of the crosslinkable silicone composition drops and the support material composition drops on the substrate or, in the subsequent course of formation of shaped parts, on the precursor of the silicone elastomer article or on the support, which has already been placed.

In a preferred embodiment of the method, the method for additive manufacturing a three-dimensional silicone elastomer article uses an extrusion 3D printer.

In an embodiment of the method, the method for additive manufacturing a three-dimensional silicone elastomer article uses an extrusion 3D printer comprising (i) at least one dispenser, e.g. a nozzle or print head, for printing the crosslinkable silicone composition X precursor of the silicone elastomer article, and (ii) at least one dispenser for printing the support composition material V.

In an embodiment of the method, the method for additive manufacturing a three-dimensional silicone elastomer article uses an extrusion 3D printer comprising (i) at least a nozzle for printing the crosslinkable silicone composition X precursor of the silicone elastomer article, and (ii) at least a nozzle for printing the support composition material V, the diameter of each nozzle being comprised from 50 to 5,000 μm, preferably from 100 to 800 μm and most preferably from 100 to 500 μm.

In an embodiment of the method, the method for additive manufacturing a three-dimensional silicone elastomer article uses an extrusion 3D printer comprising (i) at least one cartridge comprising the support material composition V to be dispensed through a nozzle, and (ii) at least one cartridge comprising the crosslinkable silicone composition X precursor of the silicone elastomer article to be dispensed through a nozzle, the diameter of each nozzle being comprised from 50 to 5,000 μm, preferably from 100 to 800 μm and most preferably from 100 to 500 μm, and the cartridge pressure being preferably comprised from 1 to 28 bars.

Contrary to other additive manufacturing methods, the method of the present invention does not need to be carried out in an irradiated or heated environment to initiate the curing after each layer is printed to avoid the collapse of the structure.

The printing steps 1) and 2) can be performed simultaneously or successively. When they are performed simultaneously, part(s) of the support and part(s) of the precursor of the silicone elastomer article are printed at the same time. When they are performed successively, step 1) can be performed before step 2), so that part(s) of the support is printed first, and then part(s) of the precursor of the silicone elastomer article is printed; or, step 2) can be performed before step 1), so that part(s) of the precursor of the silicone elastomer article is printed first, and then part(s) of the support is printed.

Steps 1) and/or 2) can be repeated several times. Each time these steps are repeated, they can be performed simultaneously or successively. For example, first part(s) of the support is printed, then part(s) of the precursor of the silicone elastomer article is printed, and finally part(s) of the support and part(s) of the precursor of the silicone elastomer article are printed simultaneously.

The crosslinking step 4) can be performed at room temperature or by heating. Advantageously, the crosslinking step 4) is performed at room temperature or by heating at a temperature less than or equal to 40° C., preferably for a period from 10 min to 24 hours. This crosslinking step can be performed several times. In an embodiment, step 4) is a step of heating the crosslinkable silicone composition X precursor of the silicone elastomer article. Heating can be used to expedite cure. In another embodiment, step 4) is a step of irradiating the crosslinkable silicone composition X precursor of the silicone elastomer article, the irradiation can be performed with UV light. Further irradiation can be used to expedite cure. In another embodiment, step 4) comprises both heating and irradiating the crosslinkable silicone composition X precursor of the silicone elastomer article.

The method may further comprise a step 5) for removing the support or support material. The support or support material can be removed mechanically, for example by brushing the printed object or by blowing the printed object with dried air, preferably in a room with recovery of dust of the support or support material.

The support or support material can also be removed by dissolution in a solvent, preferably in water, and more preferably by immersion in a stirred water bath (demineralized water, or in acidic conditions, or using a dispersing agent).

The support or support material can also be removed mechanically and by dissolution in a solvent, for example using a combination of solvent and ultrasounds.

The removing step (5) may be performed before and/or after the crosslinking step 4). According to an embodiment of the method, a first crosslinking step 4) is performed, by letting the crosslinkable silicone composition X precursor of the silicone elastomer article crosslink at room temperature or by heating the crosslinkable silicone composition X precursor of the silicone elastomer article at a temperature less than or equal to 40° C., preferably for a period from 10 min to 24 hours, then the support or support material is removed mechanically and/or by dissolution in a solvent or water, and then another crosslinking step 4) is performed, by heating the crosslinkable silicone composition X precursor of the silicone elastomer article at a temperature between 25° C. and 250° C., preferably between 30° C. and 200° C., to complete the crosslinking.

Post-Process Options

Optionally, post-processing steps can greatly improve the surface quality of the printed articles. Sanding is a common way to reduce or remove the visibly distinct layers of the model. Spraying or coating the surface of the silicone elastomer article with a heat or UV curable RTV or LSR crosslinkable silicone composition can be used to get the right smooth surface aspect.

A surfacing treatment with a laser can also be done.

For medical applications, a sterilization of the final elastomer article can be obtained for example: by heating either in a dry atmosphere or in an autoclave with vapor, for example by heating the object at a temperature greater than 100° C. under gamma ray, sterilization with ethylene oxide, sterilization with an electron beam.

The obtained silicone elastomer article can be any article with simple or complex geometry. It can be for example anatomic models (functional or non functional) such as heart, lumb, kidney, prostate, . . . , models for surgeons and educative world or orthotics or prostheses or even implants of different classes such as long term implants: hearing aids, stents, larynx implants, etc.

The obtained silicone elastomer article can also be an actuator for robotics, a gasket, a mechanical piece for automotive/aeronautics, a piece for electronic devices, a package for the encapsulation of components, a vibrational isolator, an impact isolator or a noise isolator.

Support Material Composition V

The support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof;

The at least one polyorganosiloxane A is preferably at least one polyorganosiloxane oil A, more preferably at least one linear polyorganosiloxane oil, which is a linear homopolymer or copolymer which has, per molecule, monovalent organic substituents, which are identical to or different from one another, bonded to the silicon atoms, and which are selected from the group consisting of C₁-C₆alkyl radicals, C₃-C₈ cycloalkyl radicals, C₆-C₁₀ aryl radicals and C₇-C₁₅ alkylaryl radicals.

There is no particular limitation on the viscosity of the polyorganosiloxane A as long as it is suitable for 3D printing.

Preferably, the polyorganosiloxane A may be oil or gum or mixture thereof. Preferably, the polyorganosiloxane A may have a dynamic viscosity from about 1 to 50 000 000 mPa·s at 23° C., generally from about 10 to 10 000 000 mPa·s at 23° C., more preferably about 50 to 1 000 000 mPa·s at 23° C.

As examples, mention may be made of the linear polyorganosiloxanes A:
consisting, along each chain:
   of units of formula R¹R²SiO_{2/2}, optionally combined with units of formula (R¹)₂SiO_{2/2},
   of units of formula (R²)₂SiO_{2/2}, optionally combined with units of formula (R¹)₂SiO_{2/2},
   of units of formula R¹R²SiO_{2/2} and of units of formula (R²)₂SiO_{2/2}, optionally combined with units of formula (R¹)₂SiO_{2/2},
   and blocked at each chain end by a unit of formula (R³)₃SiO_{1/2}, the R³ radicals of which, which are identical or different, are selected from R¹ and R²;
   in which the R¹ and R² radicals, monovalent organic substituents of the various siloxy units mentioned above, have the following definitions:
      the R¹ radicals, which are identical or different to one another, are selected from:
         linear C₁-C₆ or branched C₁-C₆ alkyl radicals, for instance methyl, ethyl, propyl, isopropyl, butyl, isobutyl, t-butyl, n-pentyl, n-hexyl,
         C₃-C₈ cycloalkyl radicals, for instance cyclopentyl, cyclohexyl,
         linear C₂-C₈ or branched C₃-C₈ alkenyl radicals, for instance vinyl, allyl, and
         hydroxyl radical,
      the R² radicals, which are identical or different to one another, are selected from:
         C₆-C₁₀ aryl radicals, for instance phenyl, naphthyl,
         C₇-C₁₅ alkylaryl radicals, for instance tolyl, xylyl, and
         C₇-C₁₅ arylalkyl radicals, for instance benzyl.

Preferably, the linear polyorganosiloxane A may be selected from methyl polysiloxane, vinyl polysiloxane, hydroxy polysiloxane and so on, or the mixture thereof.

Preferably, the linear polyorganosiloxane A is a non-reactive linear polyorganosiloxane oil. In the context of the invention, “non-reactive” is intended to mean an oil which, under the conditions of preparation and use of the composition, does not react chemically with any of the constituents of the composition. Preferably, the non-reactive linear polyorganosiloxane oil is a non-reactive methyl polysiloxane oil.

The polyorganosiloxane A may also be or may contain vinyl polysiloxane, hydroxy polysiloxane or mixture thereof.

The vinyl content in the vinyl polysiloxane oil is preferably 0.0001% to 29% by weight, more preferably 0.01% to 5% by weight. Preferably, said vinyl polysiloxane oil is selected from vinyl terminated polydimethylsiloxane oil.

The hydroxy content in the hydroxy polysiloxane oil is preferably 0.00001% to 30% by weight, more preferably 0.01% to 5% by weight. More preferably, said hydroxy polysiloxane oil is selected from hydroxy terminated polydimethylsiloxane oil.

The term “dynamic viscosity” is intended to mean the shear stress which accompanies the existence of a flow-rate gradient in the material. All the viscosities to which reference is made in the present document correspond to a magnitude of dynamic viscosity which is measured according to ASTM D445, in a manner known per se, at 23° C. The viscosity is generally measured using a Brookfield viscometer.

The amount of the polyorganosiloxane A present in the composition is from 1% to 99% by weight relative to the total weight of the composition, preferably from 3% to 95% and even more preferentially from 5% to 85%.

The component B is at least one polyether or polymer containing a polyether moiety. Preferably, the main chain of the polymer containing a polyether moiety contains a polyether moiety (—R⁴—O—R⁵—)ₙ and its end group(s) or side group(s) contain(s) one or more substituents R⁶, wherein R⁴ and R⁵, identical or different, represent a hydrocarbon group, preferably selected from alkyl groups having from 1 to 8 carbon atoms, such as the methyl, ethyl, propyl and 3,3,3-trifluoropropyl groups, and aryl groups, such as xylyl, tolyl and phenyl, and R⁶, identical or different, represents H, a hydrocarbon group, siloxane group, ester group, and mixture thereof, and wherein n=1 to 1000, preferably n=2 to 500, more preferably n=2-100.

Preferably, the component B is polyalkylene glycols of the following general formula

R¹⁰—[(O—CH₂—CHR⁷)ₙ(Z)ₖ(O—CH₂—CHR⁸)ₘ]—OR⁹

Wherein:

R⁷ is hydrogen or a C₁-C₄ hydrocarbon group, preferably hydrogen or a methyl,

R⁸ has the same meaning as R⁷ and can be identical to or different from R⁷,

R⁹ is hydrogen, or an optionally substituted or mono- or polyunsaturated C₁-C₂₀ hydrocarbon group, aryl group, acyl group, such as formyl, acetyl, benzoyl, acrylic, methacrylic, vinyl group, glycidoxy group, polyalkylene glycol group such as polyethylene glycol group or polypropylene glycol group having from 1 to 50 repeating units, and

R¹⁰ has the same meaning as R⁹ and can be identical to or different from R⁹,

Z is a monomer having more than 2 hydroxy groups per molecule, i.e. a branching point, for example trihydric alcohols such as propanetriol or tetrahydric alcohols such as 2,2-bis(hydroxymethyl)-1,3-propanediol, wherein the hydroxy groups in the polyalkylene glycols are etherified with the alkylene glycol monomers and thus give branched polyalkylene glycols preferably having 3 or 4 side chains, and

k is 0 or 1, and

n, m are an integer from 0 to 1000, preferably from 0 to 500, with the proviso that the sum n+m is an integer from 1 to 1000, preferably from 5 to 500.

It is preferable that the polyalkylene glycols are linear or branched, having 3 or 4 side chains per molecule.

Preference is given to polyalkylene glycols with melting points below 100° C., preferably below 50° C., with particular preference being given to polyalkylene glycols which are liquid at room temperature (=25° C.).

Preference is given to polyethylene glycols with, number-average molar mass (Mn) from 200 g/mol to 10,000 g/mol.

Preference is also given to polypropylene glycols with Mn from 200 g/mol to 10,000 g/mol.

Particular preference is given to polyethylene glycols with Mn of about 200 g/mol (PEG 200), about 400 g/mol (PEG 400), about 600 g/mol (PEG 600), and about 1000 g/mol (PEG 1000). Particular preference is given to polypropylene glycols with Mn of about 425 g/mol, about 725 g/mol, about 1000 g/mol, about 2000 g/mol, about 2700 g/mol and about 3500 g/mol.

Preference is given to linear polyethylene glycol-polypropylene glycol copolymers with Mn from 200 g/mol to 1000,000 g/mol, particularly with Mn from 1000 g/mol to 50,000 g/mol, where these can be random or block copolymers.

Preference is given to branched polyethylene glycol-polypropylene glycol copolymers with Mn from 200 g/mol to 100,000 g/mol, particularly with Mn from 1000 g/mol to 50,000 g/mol, where these can be random or block copolymers.

Preference is given to polyalkylene glycol monoethers, i.e. polyethylene glycol monoethers, polypropylene glycol monoethers and ethylene glycol-propylene glycol copolymer monoethers with Mn from 1000 g/mol to 10,000 g/mol and having an a alkyl ether moiety, such as methyl ether, ethyl ether, propyl ether, butyl other or the like.

The polyalkylene glycols can preferably be used in pure form or in any desired mixtures.

According to another embodiment, the component B is polyether modified silicone oil.

Preferably, the component B is a grafted or block polydimethylsiloxane oil comprising at least one polyether block (with, for example, polyethylene glycol and/or polypropylene glycol groups).

According to a further embodiment, the component B is an organopolysiloxane-polyoxyalkylene copolymer, also known as polydiorganosiloxane-polyether copolymers or polyalkylene oxide modified polyorganosiloxanes, are organopolysiloxanes containing siloxyl units which carry alkylene oxide chain sequences. Preferably, the organopolysiloxane-polyoxyalkylene copolymer are organopolysiloxanes containing siloxyl units which carry ethylene oxide chain sequences and/or propylene oxide chain sequences.

In a preferred embodiment, the organopolysiloxane-polyoxyalkylene copolymer is an organopolysiloxane containing siloxyl comprising units of the formula (E-1):

[R¹¹ₐZ_{b}SiO_{(4-a-b)/2}]ₙ (E-1)

in which

each R¹¹ is independently selected from hydrocarbon-based group containing from 1 to 30 carbon atoms, preferably selected from the group formed by alkyl groups containing from 1 to 8 carbon atoms, alkenyl groups containing from 2 to 6 carbon atoms and aryl groups containing between 6 and 12 carbon atoms;

each Z is a group —R¹²—(OCₚH₂ₚ)_{q}(OCH(CH₃)—CH₂)ₛ—OR¹³,

where

n is an integer greater than 2;

a and b are independently 0, 1, 2 or 3 and a+b=0, 1, 2 or 3,

R¹² is a divalent hydrocarbon group having from 2 to 20 carbon atoms or a direct bond;

R¹³ is an hydrogen atom or a group as defined for R¹¹;

p and r are independently an integer from 1 to 6;

q and s are independently 0 or an integer such that 1<q+s<400;

and wherein each molecule of the organopolysiloxane-polyoxyalkylene copolymer contains at least one group Z.

In a preferred embodiment, in the formula (E-1) above:

n is an integer greater than 2;

a and b are independently 0, 1, 2 or 3 and a+b=0, 1, 2 or 3,

R¹¹ is an alkyl group containing from 1 to 8 carbon atoms inclusive, and most preferably R¹¹ is a methyl group,

R¹² is a divalent hydrocarbon group having from 2 to 6 carbon atoms or a direct bond;

p=2 and r=3,

q is comprised between 1 and 40, most preferably between 5 and 30,

s is comprised between 1 and 40, most preferably between 5 and 30,

and R¹³ is an hydrogen atom or an alkyl group containing from 1 to 8 carbon atoms inclusive, and most preferably R¹³ is an hydrogen atom.

In a most preferred embodiment, the organopolysiloxane-polyoxyalkylene copolymer is an organopolysiloxane containing a total number of siloxyl units (E-1) comprised 1 and 200, preferably between 50 and 150 and a total number of Z groups comprised between 2 and 25, preferably between 3 and 15.

An example of organopolysiloxane-polyoxyalkylene copolymer that can be used in the method of the invention corresponds to the formula (E-2)

R^{a}₃SiO[R^{a}₂SiO]ₜ[R^{a}Si(R^{b}—(OCH₂CH₂)ₓ(OCH(CH₃)CH₂)_{y}—OH)O]ᵣSiR^{a}₃ (E-2)

where

each R^{a} is independently selected from alkyl groups containing from 1 to 8 carbon atoms and preferably R^{a} is a methyl group,

each R^{b} is a divalent hydrocarbon group having from 2 to 6 carbon atoms or a direct bond, and preferably R^{b} is a propyl group,

x and y are independently integers comprised from 1 to 40, preferably from 5 and 30, and most preferably from 10 to 30,

t is comprised from 1 to 200, preferably from 25 to 150, and

r is comprised from 2 to 25, preferably from 3 to 15.

Advantageously, in an embodiment the organopolysiloxane-polyoxyalkylene copolymer is:

Me₃SiO[Me₂SiO]₇₅[MeSi((CH₂)₃—(OCH₂CH₂)₂₂(OCH(CH₃)CH₂)₂₂—OH)O]₇SiMe₃.

In another embodiment, the organopolysiloxane-polyoxyalkylene copolymer is a branched organopolysiloxane-polyoxyalkylene copolymer comprising at least one T and/or one Q siloxy unit with Q corresponding to the siloxy unit SiO_{2/2} and T corresponding to the siloxy unit R¹¹SiO_{3/2} where R¹¹ is independently selected from hydrocarbon-based group containing from 1 to 30 carbon atoms, preferably selected from the group formed by alkyl groups containing from 1 to 8 carbon atoms, alkenyl groups containing from 2 to 6 carbon atoms and aryl groups containing between 6 and 12 carbon atoms.

In another embodiment, the organopolysiloxane-polyoxyalkylene copolymer can further comprise other functional groups selected from the group consisting of: alkenyl groups having from 2 to 6 carbon atoms, hydroxide, hydrogen, (meth)acrylate groups, amino groups and hydrolysable groups as alkoxy, enoxy, acetoxy or oxime groups.

Generally, the component B has a dynamic viscosity of 1 to 100 000 000 mPa·s at 23° C., preferably 10 to 500000 mPa·s at 23° C. and more preferably 50 to 10000 mPa·s at 23° C.

The amount of the component B present in the composition is from 0.01 to 99% by weight relative to the total weight of the composition, preferably from 0.5% to 90%, more preferentially from 1% to 85%, and even more preferentially from 3% to 80%.

The silica C may be selected from fumed silica, precipitated silica, or a mixture thereof. Preferably, the silica has an average particle size (D50) of from 0.01 to 800 μm, preferably from 0.01 to 300 μm, more preferably from 0.02 to 100 μm and most preferably from 0.03 to 30 μm. Also preferably, the silica has a BET specific surface area of greater than 0.5 m²/g, preferably between 5 and 500 m²/g, more preferably 50 and 400 m²/g and most preferably between 100 and 300 m²/g, as determined according to BET method.

The silica C may be treated or not treated. That is, the silica may be used in unmodified form or after having been treated with treating compounds usually used for this purpose. Among these treating compounds are methylpolysiloxanes such as hexamethyldisiloxane, octamethylcyclotetrasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane.

The amount of the silica C present in the composition is from 0.5% to 60% by weight relative to the total weight of the composition, preferably from 1% to 40%, and even more preferentially from 2% to 30%, and even more preferentially from 5% to 20%.

The support material composition may optionally comprise one or more other additives so long as they do not interfere with or adversely affect the target properties of the composition.

The amount of the other additives present in the support material composition is from 0% to 20% by weight relative to the total weight of the composition, preferably from 0.5% to 10% and even more preferentially from 1% to 5%.

The composition may further comprise at least one additive selected from: rheology additive, coloration agents, pH adjusters, antimicrobial agents, dispersing agents, anti-aging agents, and mixtures thereof.

The composition according to the invention may also comprise other fillers like a standard semi-reinforcing or packing filler, hydroxyl functional silicone resins, pigments, or adhesion promoters.

Non siliceous minerals that may be included as semi-reinforcing or packing mineral fillers can be selected from the group constituted of: carbon black, titanium dioxide, aluminium oxide, hydrated alumina, calcium carbonate, ground quartz, diatomaceous earth, zinc oxide, mica, talc, iron oxide, barium sulfate and slaked lime.

There is no particular limitation on the viscosity of the support material composition according to the present invention as long as it is suitable for 3D printing.

Preferably, the support material composition according to the present invention may have a dynamic viscosity from about 100 to 50 000 000 mPa·s at 23° C., generally from about 5000 to 10 000 000 mPa·s at 23° C., and most preferably 50 000 to 5 000 000 mPa·s at 23° C.

Advantageously, the support material composition has thixotropic properties. Preferably, the support material composition has a thixotropic index of 2 to 100, preferably 3 to 60, and more preferably 4-50, and most preferably 3.5-50.

The the support material composition according to the present invention may be prepared according to the common methods known to the person skilled in the art. For example, the support material composition may be prepared by mixing various components.

Use of the Support Material Composition V

The present invention also relates to the use of a support material composition V for 3D printing a support, preferably by extrusion, wherein the support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof.

The support material composition V is the one described herein. The 3D printing of the support is preferably done using an extrusion 3D printer comprising (i) at least one dispenser for printing the support composition material V. In an embodiment, the extrusion 3D printer comprises (i) at least a nozzle for printing the support composition material V, the diameter of each nozzle being comprised from 50 to 5,000 μm, preferably from 100 to 800 μm and most preferably from 100 to 500 μm.

The present invention also relates to the use of a support material composition V for additive manufacturing a silicone elastomer article and a support using a 3D printer, preferably an extrusion 3D printer, wherein the support material composition V comprises:
(A) at least one polyorganosiloxane A, preferably linear polyorganosiloxane;
(B) at least one polyether or polymer containing polyether moiety B;
(C) silica C, preferably selected from fumed silica, precipitated silica or the mixture thereof.

In an embodiment, the 3D printer is an extrusion 3D printer comprising (i) at least one dispenser, e.g. a nozzle or print head, for printing the crosslinkable silicone composition X precursor of the silicone elastomer article, and (ii) at least one dispenser for printing the support composition material V.

In an embodiment, the extrusion 3D printer comprises (i) at least a nozzle for printing the crosslinkable silicone composition X precursor of the silicone elastomer article, and (ii) at least a nozzle for printing the support composition material V, the diameter of each nozzle being comprised from 50 to 5,000 μm, preferably from 100 to 800 μm and most preferably from 100 to 500 μm.

In an embodiment of the method, the method for additive manufacturing a three-dimensional silicone elastomer article uses an extrusion 3D printer comprising (i) at least one cartridge comprising the support material composition V to be dispensed through a nozzle, and (ii) at least one cartridge comprising the crosslinkable silicone composition X precursor of the silicone elastomer article to be dispensed through a nozzle, the diameter of each nozzle being comprised from 50 to 5,000 μm, preferably from 100 to 800 μm and most preferably from 100 to 500 μm, and the cartridge pressure being preferably comprised from 1 to 28 bars.

Crosslinkable Silicone Composition X (Building Material Composition)

The crosslinkable silicone composition X precursor of the silicone elastomer article may be any silicone composition crosslinkable, for example via polyaddition reaction or via polycondensation reaction, suitable for 3D printing, which is well known for the person skilled in the art.

As a non-limiting example, the crosslinkable silicone composition X precursor of the silicone elastomer article may be a silicone composition crosslinkable via polyaddition. In this embodiment, the composition X may comprises:

(A′) at least one organopolysiloxane compound A′ comprising, per molecule at least two C₂-C₆ alkenyl radicals bonded to silicon atoms,

(B′) at least one organohydrogenopolysiloxane compound B′ comprising, per molecule, at least two hydrogen atoms bonded to an identical or different silicon atom,

(C′) at least one catalyst C′ consisting of at least one metal or compound, from the platinum group,

(D′) optionally at least one filler D′,

(E′) optionally at least thixotropic agent E′, and

(F′) optionally at least one crosslinking inhibitor F′.

According to a particularly advantageous mode, the organopolysiloxane A′ comprising, per molecule, at least two C₂-C₆ alkenyl radicals bonded to silicon atoms, comprises:
(i) at least two siloxyl units (A′.1), which may be identical or different, having the following formula:

$${W}_{a} {Z}_{b} {SiO}_{\frac{4 - ( a + b )}{2}} \qquad ( {A}^{′} \text{.1} )$$

in which:
   a=1 or 2, b=0, 1 or 2 and a+b=1, 2 or 3;
   the symbols W, which may be identical or different, represent a linear or branched C₂-C₆ alkenyl group,
   and the symbols Z, which may be identical or different, represent a monovalent hydrocarbon-based group containing from 1 to 30 carbon atoms, preferably selected from the group formed by alkyl groups containing from 1 to 8 carbon atoms and aryl groups containing between 6 and 12 carbon atoms, and even more preferentially selected from the group formed by methyl, ethyl, propyl, 3,3,3-trifluoropropyl, xylyl, tolyl and phenyl radicals,
(ii) and optionally at least one siloxyl unit having the following formula:

$${Z}_{a}^{1} {SiO}_{\frac{4 - a}{2}} \qquad ( {A}^{′} \text{.2} )$$

in which:
   a=0, 1, 2 or 3,
   the symbols Z¹, which may be identical or different, represent a monovalent hydrocarbon-based group containing from 1 to 30 carbon atoms, preferably selected from the group formed by alkyl groups containing from 1 to 8 carbon atoms inclusive and aryl groups containing between 6 and 12 carbon atoms, and even more preferentially selected from the group formed by methyl, ethyl, propyl, 3,3,3-trifluoropropyl, xylyl, tolyl and phenyl radicals.

Advantageously, Z and Z¹ are selected from the group formed by methyl and phenyl radicals, and W is selected from the following list: vinyl, propenyl, 3-butenyl, 5-hexenyl, 9-decenyl, 10-undecenyl, 5,9-decadienyl and 6-11-dodecadienyl, and preferably, W is a vinyl.

These organopolysiloxanes may have a linear, branched or cyclic structure. Their degree of polymerization is preferably between 2 and 5000.

When they are linear polymers, they are essentially formed from siloxyl units “D” selected from the group formed by the siloxyl units W₂SiO_{2/2}, WZSiO_{2/2} and Z¹₂SiO_{2/2}, and from siloxyl units “M” selected from the group formed by the siloxyl units W₃SiO_{1/2}, WZ₂SiO_{1/2}, W₂ZSiO_{1/2} and Z¹³SiO_{1/2}. The symbols W, Z and Z¹ are as described above.

As examples of end units “M”, mention may be made of trimethylsiloxy, dimethylphenylsiloxy, dimethylvinylsiloxy or dimethylhexenylsiloxy groups.

As examples of units “D”, mention may be made of dimethylsiloxy, methylphenylsiloxy, methylvinylsiloxy, methylbutenylsiloxy, methylhexenylsiloxy, methyldecenylsiloxy or methyldecadienylsiloxy groups.

Said organopolysiloxanes A′ may be oils with a dynamic viscosity from about 10 to 100 000 mPa·s at 23° C., generally from about 10 to 70 000 mPa·s at 23° C., or gums with a dynamic viscosity of about 1 000 000 mPa·s or more at 23° C.

Preferably, the organopolysiloxane compound A′ has a mass content of Si-vinyl units of between 0.001 and 30%, preferably between 0.01 and 10%.

According to a preferred embodiment, the organohydrogenopolysiloxane compound B′ is an organopolysiloxane containing at least two hydrogen atoms per molecule, bonded to an identical or different silicon atom, and preferably containing at least three hydrogen atoms per molecule directly bonded to an identical or different silicon atom.

Advantageously, the organohydrogenopolysiloxane compound B′ is an organopolysiloxane comprising:
(i) at least two siloxyl units and preferably at least three siloxyl units having the following formula:

$${H}_{d} {Z}_{e}^{3} {SiO}_{\frac{4 - ( d + e )}{2}} \qquad ( {B}^{′} \text{.1} )$$

in which:
   d=1 or 2, e=0, 1 or 2 and d+e=1, 2 or 3,
   the symbols Z³, which may be identical or different, represent a monovalent hydrocarbon-based group containing from 1 to 30 carbon atoms, preferably selected from the group formed by alkyl groups containing from 1 to 8 carbon atoms and aryl groups containing between 6 and 12 carbon atoms, and even more preferentially selected from the group formed by methyl, ethyl, propyl, 3,3,3-trifluoropropyl, xylyl, tolyl and phenyl radicals, and
(ii) optionally at least one siloxyl unit having the following formula:

$${Z}_{c}^{2} {SiO}_{\frac{4 - c}{2}} \qquad ( {B}^{′} \text{.2} )$$

in which:
   c=0, 1, 2 or 3,
   the symbols Z², which may be identical or different, represent a monovalent hydrocarbon-based group containing from 1 to 30 carbon atoms, preferably selected from the group formed by alkyl groups containing from 1 to 8 carbon atoms and aryl groups containing between 6 and 12 carbon atoms, and even more preferentially selected from the group formed by methyl, ethyl, propyl, 3,3,3-trifluoropropyl, xylyl, tolyl and phenyl radicals.

The organohydrogenopolysiloxane compound B′ may be formed solely from siloxyl units of formula (B′.1) or may also comprise units of formula (B′.2). It may have a linear, branched or cyclic structure. The degree of polymerization is preferably greater than or equal to 2. More generally, it is less than 5000.

Examples of siloxyl units of formula (B′.1) are especially the following units: H(CH₃)₂SiO_{1/2}, HCH₃SiO_{2/2} and H(C₆H₅)SiO_{2/2}.

When they are linear polymers, they are essentially formed from:
siloxyl units “D” selected from the units having the following formulae Z²₂SiO_{2/2} or Z³HSiO_{2/2}, and
siloxyl units “M” selected from the units having the following formulae Z²₃SiO_{1/2} or Z³₂HSiO_{1/2},
the symbols Z² and Z³ are as described above.

These linear organopolysiloxanes may be oils with a dynamic viscosity from about 1 to 100 000 mPa·s at 23° C., generally from about 10 to 5000 mPa·s at 23° C., or gums with a dynamic viscosity of about 1 000 000 mPa·s or more at 23° C.

When they are cyclic organopolysiloxanes, they are formed from siloxyl units “D” having the following formulae Z²₂SiO_{2/2} and Z³HSiO_{2/2}, which may be of the dialkylsiloxy or alkylarylsiloxy type or units Z³HSiO_{2/2} solely, the symbols Z² and Z³ are as described above. They have a viscosity from about 1 to 5000 mPa·s.

Examples of linear organohydrogenopolysiloxane compounds B′ are: dimethylpolysiloxanes bearing hydrogenodimethylsilyl end groups, dimethylhydrogenomethylpolysiloxanes bearing trimethylsilyl end groups, dimethylhydrogenomethylpolysiloxanes bearing hydrogenodimethylsilyl end groups, hydrogenomethylpolysiloxanes bearing trimethylsilyl end groups, and cyclic hydrogenomethylpolysiloxanes.

The oligomers and polymers corresponding to the general formula (B′.3) are especially preferred as organohydrogenopolysiloxane compound B′:

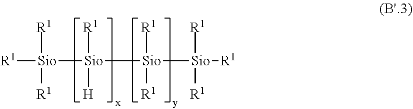

in which:
   x and y are an integer ranging between 0 and 200,
   the symbols R¹, which may be identical or different, represent, independently of each other:
      a linear or branched alkyl radical containing 1 to 8 carbon atoms, optionally substituted with at least one halogen, preferably fluorine, the alkyl radicals preferably being methyl, ethyl, propyl, octyl and 3,3,3-trifluoropropyl,
      a cycloalkyl radical containing between 5 and 8 cyclic carbon atoms,
      an aryl radical containing between 6 and 12 carbon atoms, or
      an aralkyl radical bearing an alkyl part containing between 5 and 14 carbon atoms and an aryl part containing between 6 and 12 carbon atoms.

The following compounds are particularly suitable for the invention as organohydrogenopolysiloxane compound B′:

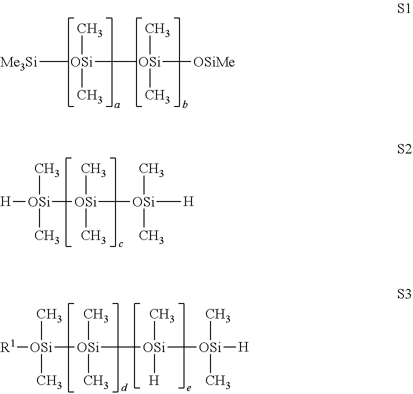

with a, b, c, d and e defined below:
   in the polymer of formula Si:
      0≤a≤150, preferably 0≤a≤100, and more particularly 0≤a≤20, and
      1≤b≤90, preferably 10≤b≤80 and more particularly 30≤b≤70,
   in the polymer of formula S2: 0≤c≤100, preferably, 0≤c≤15,
   in the polymer of formula S3: 5≤d≤200, preferably 20≤d≤100, and 2≤e≤90, preferably 10≤e≤70.

In particular, the organohydrogenopolysiloxane compound B′ that is suitable for use in the invention is the compound of formula S1, in which a=0.

Preferably, the organohydrogenopolysiloxane compound B′ has a mass content of SiH units of between 0.2 and 91%, preferably between 0.2 and 50%.

Catalyst C′ consisting of at least one metal, or compound, from the platinum group are well known. The metals of the platinum group are those known under the name platinoids, this term combining, besides platinum, ruthenium, rhodium, palladium, osmium and iridium. Platinum and rhodium compounds are preferably used. Complexes of platinum and of an organic product described in U.S. Pat. Nos. A 3,159,601, A 3,159,602, A 3,220,972 and European patents EP A 0 057 459, EP A 0 188 978 and EP A 0 190 530, and complexes of platinum and of vinylorganosiloxanes described in patents U.S. Pat. Nos. A 3,419,593, A 3,715,334, A 3,377,432 and A 3,814,730 may be used in particular. Specific examples are: platinum metal powder, chloroplatinic acid, a complex of chloroplatinic acid with β-diketone, a complex a chloroplatinic acid with olefin, a complex of a chloroplatinic acid with 1,3-divinyltetramethyldisiloxane, a complex of silicone resin powder that contains aforementioned catalysts, a rhodium compound, such as those expressed by formulae: RhCl(Ph₃P)₃, RhCl₃[S(C₄H₉)₂]₃, etc.; tetrakis(triphenyl)palladium, a mixture of palladium black and triphenylphosphine, etc.

The platinum catalyst ought preferably to be used in a catalytically sufficient amount, to allow sufficiently rapid crosslinking at room temperature. Typically, 1 to 200 ppm by weight of the catalyst are used, based in the amount of Pt metal, relative to the total silicone composition preferably 1 to 100 ppm by weight, more preferably 1 to 50 ppm by weight.

To allow a sufficiently high mechanical strength the addition-crosslinking silicone compositions can comprise filler, such as for example silica fine particles, as reinforcing fillers D′. Precipitated and fumed silicas and mixtures thereof can be used. The specific surface area of these actively reinforcing fillers ought to be at least 50 m²/g and preferably in the range from 100 to 400 m²/g as determined by the BET method. Actively reinforcing fillers of this kind are very well-known materials within the field of the silicone rubbers. The stated silica fillers may have hydrophilic character or may have been hydrophobized by known processes.

The amount of the silica reinforcing filler D′ in the addition-crosslinking silicone compositions is in the range from 5% to 40% by weight, preferably 10% to 35% by weight of the total composition. If this blend quantity is less than 5% by weight, then adequate elastomer strength may not be obtainable, whereas if the blend quantity exceeds 40% by weight, the actual blending process may become difficult.

The silicone compositions according to the invention may also comprise other fillers like a standard semi-reinforcing or packing filler, hydroxyl functional silicone resins, pigments, or adhesion promoters.

Non siliceous minerals that may be included as semi-reinforcing or packing mineral fillers can be selected from the group constituted of: carbon black, titanium dioxide, aluminium oxide, hydrated alumina, calcium carbonate, ground quartz, diatomaceous earth, zinc oxide, mica, talc, iron oxide, barium sulfate and slaked lime.

The crosslinkable silicone composition X can also comprise a thixotropic agent E′ which is a rheological agent which serves to adjust the shear-thinning and thixotropic characteristics.

In an embodiment, the thixotropic agent E′ contains polar groups. Preferably the thixotropic agent E′ can be selected from the group consisting of: an organic or organosilicon compound having at least one epoxy group, an organic or organopolysiloxane compound having at least one (poly)ether group, an organic compound having at least (poly)ester group, an organopolysiloxane having at least one aryl group and any combination thereof.

Crosslinking inhibitors F′ are commonly used in addition crosslinking silicone compositions to slow the curing of the composition at ambient temperature. The crosslinking inhibitor F′ may be selected from the following compounds:
acetylenic alcohols;
organopolysiloxanes substituted with at least one alkenyl that may optionally be in cyclic form, tetramethylvinyltetrasiloxane being particularly preferred;
pyridine;
organic phosphines and phosphites;
unsaturated amides, and -alkyl and allyl maleates.

These acetylenic alcohols (Cf. FR-B-1 528 464 and FR-A-2 372 874), which are among the preferred hydrosilylation-reaction thermal blockers, have the formula:

(R′)(R″)(OH)C—C≡CH

in which:
R′ is a linear or branched alkyl radical, or a phenyl radical; and
R″ is H or a linear or branched alkyl radical, or a phenyl radical; the radicals R′ and R″ and the carbon atom a to the triple bond possibly forming a ring.

The total number of carbon atoms contained in R′ and R″ being at least 5 and preferably from 9 to 20. For the said acetylenic alcohols, examples that may be mentioned include:
1-ethynyl-1-cyclohexanol;
3-methyl-1-dodecyn-3-ol;
3,7,11-trimethyl-1-dodecyn-3-ol;
1,1-diphenyl-2-propyn-1-ol;
3-ethyl-6-ethyl-1-nonyn-3-ol;
2-methyl-3-butyn-2-ol;
3-methyl-1-pentadecyn-3-ol; and
diallyl maleate or diallyl maleate derivatives.

### DESCRIPTION OF THE FIGURES

FIG. 1 is a photograph showing a silicone elastomer article formed by the building material before removing the support material.

FIG. 2 is a photograph showing a silicone elastomer article formed by the building material after removing the support material.

### MODE OF CARRYING OUT THE INVENTION

The scope and interest of the invention will be better understood based on the following examples which are intended to illustrate certain embodiments of the present invention and are non-limitative.

### Examples

The raw materials of the support material used in the examples are listed in the following Table 1, and formulas and test results of the support material can be found in Tables 2-1 and 2-2.

TABLE 1
The description of structure of raw
materials of the support material

| Raw | |
|---|---|
| materials | Chemical description or structure |
| A-1 | Non-reactive methyl polysiloxane, viscosity: 50 mPa · s |
| A-2 | Non-reactive methyl polysiloxane, viscosity: 1000 mPa · s |
| A-3 | Vinyl terminated Polydimethylsiloxane, viscosity: 100000 |
| | mPa · s, vinyl content: 0.08 wt % |
| A-4 | Hydroxy terminated Polydimethylsiloxane, viscosity: 14000 |
| | mPa · s Hydroxy content: 0.014 wt % |
| B-1 | CAS NO.: 68937-55-3, Siloxanes and Silicones, dimethyl, |
| | 3-hydroxypropyl methyl, ethoxylated propoxylated |
| B-2 | CAS NO.: 69011-36-5 Alcohol iso-C13, poly (12) ethoxylate |
| B-3 | CAS NO.: 9004-81-3 Polyethylene glycol monolaurate |
| C-1 | CAS NO.: 112945-52-5 Particle size (D50) is 10 μm, specific |
| | surface area is 190 m2/g ACEMATT ® 3300 is an |
| | advanced polymer-treated thermal silica |
| C-2 | Fumed silica treated by D4, specific surface area is about |
| | 235 m²/g |

TABLE 2-1
Formulas and test results of silicone support materials

| Raw | Example | Example | Example | Example | Example | Example | Example | Example | Example |
|---|---|---|---|---|---|---|---|---|---|
| materials | 1 | 2 | 3 | 4 | 5 | 6 | 7 | 8 | 9 |
| A-1 | 0 | 0 | 0 | 0 | 0 | 0 | 0 | 0 | 40 |
| A-2 | 0 | 80 | 0 | 60 | 80 | 85 | 80 | 0 | 0 |
| A-3 | 5 | 0 | 0 | 0 | 0 | 0 | 0 | 70 | 0 |
| A-4 | 0 | 0 | 80 | 0 | 0 | 0 | 0 | 0 | 0 |
| B-1 | 80 | 10 | 10 | 0 | 0 | 5 | 0 | 25 | 50 |
| B-2 | 0 | 0 | 0 | 30 | 10 | 0 | 0 | 0 | 0 |
| B-3 | 0 | 0 | 0 | 0 | 0 | 0 | 10 | 0 | 0 |
| C-1 | 15 | 10 | 10 | 10 | 10 | 10 | 0 | 5 | 10 |
| C-2 | 0 | 0 | 0 | 0 | 0 | 0 | 10 | 0 | 0 |
| Total | 100 | 100 | 100 | 100 | 100 | 100 | 100 | 100 | 100 |
| Test | | | | | | | | | |
| results | | | | | | | | | |
| viscosity | 629000 | 610000 | 1780000 | 860000 | 775000 | 1970000 | 946000 | 392000 | 1250000 |
| η | | | | | | | | | |
| (mPa · s) | | | | | | | | | |
| at [0.5 s − | | | | | | | | | |
| 1], 23° C. | | | | | | | | | |
| viscosity | 64000 | 32000 | 100000 | 40000 | 29000 | 47000 | 27000 | 105000 | 80000 |
| η | | | | | | | | | |
| (mPa · s) | | | | | | | | | |
| at [25 s − | | | | | | | | | |
| 1], 23° C. | | | | | | | | | |
| Thixotro | 10 | 19 | 18 | 21 | 27 | 42 | 35 | 4 | 16 |
| pic index | | | | | | | | | |
| Status | thixotropic | thixotropic | thixotropic | thixotropic | thixotropic | thixotropic | thixotropic | thixotropic | thixotropic |
| Dissolution | 0.5 | 0.5 | 0.5 | 0.5 | 0.67 | 168 | 168 | 1 | 0.5 |
| time | | | | | | | | | |
| in | | | | | | | | | |
| water/ | | | | | | | | | |
| h, 23° C. | | | | | | | | | |

TABLE 2-2
Formulas and test results of silicone support materials

| | Comparative | Comparative | Comparative |
|---|---|---|---|
| | Example 1 | Example 2 | Example 3 |
| Raw materials | | | |
| A-1 | 0 | 0 | 0 |
| A-2 | 90.91 | 0 | 0 |
| A-3 | 0 | 0 | 0 |
| A-4 | 0 | 0 | 0 |
| B-1 | 0 | 90.91 | 0 |
| B-2 | 0 | 0 | 0 |
| B-3 | 0 | 0 | 90.91 |
| C-1 | 9.09 | 9.09 | 9.09 |
| C-2 | 0 | 0 | 0 |
| Total | 100 | 100 | 100 |
| Test results | | | |
| Viscosity, mPa · s, | 26000 | 26500 | 6000 |
| (5#, 10 rpm, 23° C.) | | | |
| Status | flowable | flowable | flowable |

Experiments

In example 1, all of the raw materials are mixed according to weight ratio as indicated in the Table 2-1. Specifically, 5 parts of A-3 and 80 parts of B-1 are mixed with 15 parts of silica C-1 sufficiently, to obtain the support material composition of example 1. Examples 2-9 and comparative examples 1-3 are also prepared in a similar process according to the weight ratio as indicated in the Tables 2-1 and 2-2.

Properties Assessment

According to the invention, assessment results of the samples are listed in the Table 2-1 and Table 2-2.

Rheological test: A rotational rheometer (Haake Rheometer) is used to define the rheological behavior of samples based on examples 1-9. A thixotropic test is performed in two parts at 25° C. using cone-plate (35 mm, 1°, gap=52 μm) in order to keep a constant shear rate in samples. The first part is a pre-shear test in order to destroy the material's microstructure as in 3D printing conditions (3 s at 5 s⁻¹). The second part is a time sweep test in order to define the thixotropic performance of samples. An equivalent shear thinning test was performed to define a “viscosity ratio” which allows users to evaluate the material's performance in 3D printing. The “ratio” is calculated with the dynamic viscosity at low and high shear rate: 0.5 and 25 s⁻¹ respectively. A high value of “viscosity ratio” means that material is able to product 3D objects with high quality.

In this method, the support materials of the present examples show the adequate rheological properties necessary to avoid collapse or deformation of the silicone elastomer articles at room temperature before complete curing. Preferably, the “thixotropic index” of the support material composition is defined as the ratio of the dynamic viscosity at low (0.5 s⁻¹) and high shear rate (25 s⁻¹). The higher thixotropic index means the better thixotropic performance of the support materials. Generally, the thixotropic index of more than or equal to 2 is well for the support material.

Viscosity test: According to ASTM D445, the viscosity of the samples based on comparative examples 1-3 is tested at 23° C., the detail of testing conditions can be seen in the table 2-2.

The above testing methods are employed to show if the samples can be used as support materials. Generally, the status of “thixotropic” as determined by the viscometer is a precondition for good shaping of support materials. The status of “flowable” as determined by the viscometer offers a proof that samples from comparative examples cannot keep good shape well.

Dissolution test: 3 g sample of the support material is put into 30 g of water and left to stand until the sample is completely dissolved (no obvious agglomeration was seen in the solution). Dissolution time can be seen in Table 2-1.

The inventors also test the dissolution time of the support material sample in organic solvents such as isopropanol and cyclohexane. In a similar way, for example, 3 g sample of the support material from example 2 is put into 30 g of isopropanol and 30 g hexane respectively and left to stand until the sample is completely dissolved (no obvious agglomeration was seen in the solution). Dissolution time in isopropanol and in hexane are all 0.5 h.

Dissolution property in solvent such as in organic solvents or in water is a key parameter in removing support materials. Proper support materials can be removed completely and will not have an adverse effect on building materials. It can be seen from the above tests that the support material according to the present invention has a suitable dissolution time in water, isopropanol and hexane, indicating that the support material of the present invention can be easily removed by a solvent, especially water.

A support material requires suitable thixotropic property during printing process meanwhile it can be removed easily such as dissolution in water or organic solvent quickly. To achieve the target, the combination of the components A, B and C plays a key role in the support material. In the examples, the combination of the components A, B and C exhibits ideal effect such as good thixotropy and fast dissolution speed in water or organic solvent. The support materials in the comparative examples cannot exhibit good thixotropy due to absence of component A or B.

3D Printing Process

The 3D printing process is carried out by using a 3D printer based on extrusion process. The Printer has been equipped with two extrusion systems and two nozzles. One extrusion system is for a building material, the other one is for a support material.

The building material is prepared as below.

Raw materials of the building material composition are mixed according to weight ratio. 57.28 parts of vinyl terminated Polydimethylsiloxane (viscosity: 1500 mPa·s, vinyl content: 0.26 wt %) and 7.05 parts of vinyl terminated Polydimethylsiloxane (viscosity: 600 mPa·s, vinyl content: 0.38 wt %) are mixed with 24.59 parts of treated silica (CAS NO: 68988-89-6). 0.36 part of 2,4,6,8-Tetramethyl-2,4,6,8-tetravinylcyclotetrasiloxane (CAS NO.: 2554-06-5) is added and then mixed sufficiently. 2.16 parts of Poly(methylhydrogeno)(dimethyl)siloxane with SiH groups in-chain and end-chain (α/ω) (viscosity: 300 μmPa·s, SiH content: 4.75 wt %), 1.72 parts of Poly(methylhydrogeno)(dimethyl)siloxane with SiH groups in-chain and end-chain (α/ω) (viscosity: 25 μmPa·s, —SiH content: 20 wt %) and 1.72 parts of Poly(methylhydrogeno)(dimethyl)siloxane with SiH groups in-chain and end-chain (α/ω) (viscosity: 8.5 mPa·s, SiH content: 5.5 wt %), are added and stirred, following with 0.017 part of catalyst Platinum(0)-1,3-divinyl-1,1,3,3-tetramethyldisiloxane (Pt content: 10 wt %) and 2 part of vinyl terminated methyl phenyl polysiloxane (viscosity: 800 mPa·s, phenyl content: 15 wt %, refractive index: 1.46) to obtain polyaddition build materials. The viscosity of the build materials is 790000 mPa·s (7#, 2 rpm, 23° C.) and 161400 mPa·s (7#, 20 rpm, 23° C.)). The ratio of viscosities at different shear force is 4.9, which indicates the build material can be extruded via printer nozzle and keep shape very well.

The support material is prepared based on example 2 from Table 2-1.

Printing process is as follows:

I. Loading the building material and the support material into extruding systems respectively. The nozzle diameter used is 0.4 mm. The distance between the nozzle and the substrate is about 0.4 mm;

II. Level adjusting the printing platform and setting printing parameters;

III. Printing a silicone elastomer article as follows:

1) printing at least one part of the support material composition as defined in example 2 from Table 2-1,

2) printing at least one part of the building material composition as defined above, steps 1) and 2) being done successively, and step 2) is performed before step 1)

3) repeating step 1) and step 2) respectively multiple times according to the desired shape of the final article;

4) allowing the building material composition to crosslink at room temperature for 24 hours;

5) removing the support by dissolution in water with ultrasonic device.

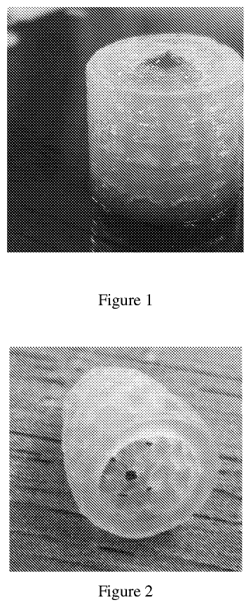

The obtained product is for example shown in FIG. 1-2. As indicated above, FIG. 1 shows the silicone elastomer article before removing the support material, whereas FIG. 2 shows the silicone elastomer article after removing the support material.

The obtained silicone elastomer article is well formed, and the support material can be removed easily and quickly.

1. A method for additive manufacturing a silicone elastomer article using a 3D printer selected from an extrusion 3D printer and a 3D jetting printer, said method comprising:
1) printing at least one part of a support material composition V, wherein the support material composition V comprises:
(A) at least one polyorganosiloxane A, optionally linear polyorganosiloxane;
(B) at least one polyether or polymer containing polyether moiety B;
(C) silica C, optionally selected from fumed silica, precipitated silica or the mixture thereof;
2) printing at least one part of a building material composition, which is a crosslinkable silicone composition X precursor of the silicone elastomer article; 1) and 2) being done simultaneously or successively, and when 1) and 2) are done successively, 1) can be performed before 2), or 2) can be performed before 1);
3) optionally repeating 1) and/or 2); and
4) allowing the crosslinkable silicone composition X precursor of the silicone elastomer article to crosslink, optionally by heating, to obtain a silicone elastomer article;
5) removing the support material, optionally, by dissolution in a solvent, optionally in water, and/or mechanically.

2. The method according to claim 1, wherein the at least one polyorganosiloxane A is at least one polyorganosiloxane oil A, optionally at least one linear polyorganosiloxane oil, which is a linear homopolymer or copolymer which has, per molecule, monovalent organic substituents, which are identical to or different from one another, bonded to the silicon atoms, and which are selected from the group consisting of C₁-C₆ alkyl radicals, C₃-C₈ cycloalkyl radicals, C₆-C₁₀ aryl radicals and C₇-C₁₅ alkylaryl radicals.

3. The method according to claim 1, wherein the polyorganosiloxane A is selected from vinyl polysiloxane, hydroxy polysiloxane or mixture thereof, optionally selected from vinyl terminated polydimethylsiloxane, hydroxy terminated polydimethylsiloxane or a mixture thereof.

4. The method according to claim 1, wherein the polyorganosiloxane A has a dynamic viscosity from about 1 to 50 000 000 mPa·s at 23° C., optionally from about 10 to 10 000 000 mPa·s at 23° C., optionally about 50 to 1 000 000 mPa·s at 23° C.

5. The method according to claim 1, wherein the silica C) is selected from treated silica or non-treated silica, optionally selected from treated silica.

6. The method according to claim 1, wherein said support material composition X comprises:
1% to 99% by weight, optionally 3% to 95% by weight and optionally 5 to 85% by weight of polyorganosiloxane A, and/or
0.01 to 99% by weight, optionally 0.5% to 90%, optionally 1 to 85% by weight and optionally 3 to 80% by weight of component B, and/or
0.5% to 60% by weight, optionally 1% to 40%, optionally 2% to 30%, and optionally 5% to 20% of silica C, relative to the total weight of the support material composition X.

7. The method according to claim 1, wherein said support material composition X has a thixotropic index of 2 to 100, optionally 3 to 60, and optionally 3.5-50.

8. A silicone elastomer article obtainable by the method according to claim 1.

9. A method for additive manufacturing a silicone elastomer article and a support using a 3D printer selected from an extrusion 3D printer and a 3D jetting printer, said method comprising:
1) printing at least one part of the support with a support material composition V, wherein the support material composition V comprises:
(A) at least one polyorganosiloxane A, optionally linear polyorganosiloxane;
(B) at least one polyether or polymer comprising polyether moiety B;
(C) silica C, optionally selected from fumed silica, precipitated silica or a mixture thereof;
2) printing at least one part of a building material composition, which is a crosslinkable silicone composition X precursor of the silicone elastomer article; 1) and 2) being done simultaneously or successively, and when 1) and 2) are done successively, 1) can be performed before 2), or 2) can be performed before 1);
3) optionally, repeating 1) and/or 2); and
4) allowing the crosslinkable silicone composition X precursor of the silicone elastomer article to crosslink, optionally by heating, to obtain a silicone elastomer article.

10. A product comprising a support material composition V in 3D printing, optionally by using a 3D printer selected from an extrusion 3D printer and a 3D jetting printer, wherein the support material composition V comprises:
(A) at least one polyorganosiloxane A, optionally linear polyorganosiloxane;
(B) at least one polyether or polymer containing polyether moiety B;
(C) silica C, optionally selected from fumed silica, precipitated silica or a mixture thereof.

11. A support material composition V comprising:
(A) at least one polyorganosiloxane A, optionally linear polyorganosiloxane;
(B) at least one polyether or polymer containing polyether moiety B;
(C) silica C, optionally selected from fumed silica, precipitated silica or a mixture thereof.
